(19) United States
(12) Patent Application Publication
(10) Pub. No.: US 2008/0211134 A1
(43) Pub. Date: Sep. 4, 2008

(54) Method and apparatus for making spiral separators using sequential heating and cooling

(75) Inventor: Thomas J. Grey, Jacksonville, FL (US)

Correspondence Address: ARTHUR G. YEAGER, P.A., 245-1 EAST ADAMS STREET, JACKSONVILLE, FL, 32202-3336, US

(73) Assignee: Outotec Oyj

(21) Appl. No.: 12/151,658

(22) Filed: May 8, 2008

Related U.S. Application Data
(63) Continuation-in-part of application No. 11/594,682, filed on Nov. 8, 2006.

(51) Int. Cl. B29C 33/40; B28B 11/24; B29C 35/02

(52) U.S. Cl. 264/220; 425/446; 425/174.6

(57) ABSTRACT

A mold for the interior surfaces of one or more spirals is rotated and heated to a temperature sufficient to melt a weldable plastic such as LLDP or HDP plastic in a predetermined amount deposited thereon. Plastic powder not melted is recovered and redeposited until all the plastic powder is melted. The mold or molds are then actively cooled and the formed spiral is removed. An insulation layer is used to improve heating and cooling efficiency, and to control the areas where plastic is deposited. A cover closes the back of the mold.

### CROSS-REFERENCE TO RELATED APPLICATION

This application is a continuation-in-part of commonly owned application Ser. No. 11/594,682 filed Nov. 8, 2006, entitled Method and Apparatus for Making Spiral Separators.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates to plastic molding techniques and apparatus and particularly to methods and apparatus for molding plastic spirals used in spiral separators.

2. Revelant Art

Many techniques exist for molding plastic parts. A well known technique for manufacturing plastic parts is called roto-molding, which works as follows: a thin walled, hollow metal mold is created for a ball, for example. The mold has a cavity that is shaped like a ball and the mold can be opened in half like a clamshell. A measured amount of powdered thermoplastic material, like HDPE (High Density Polyethylene) or LLDPE (Linear Low Density Polyethylene) is put inside the mold and the mold is closed. The mold is then rotated (two axis) inside an oven. As the mold is heated and rotated the powder begins to melt and cling to the inside of the cavity and this occurs until all of the powder is melted. The mold is then cooled and opened. One then extracts a molded, hollow ball made of plastic. More complex parts can be made with additional complexity in the molds. This method is used for making children's toys, agricultural liquid tanks, barrels, drums and many other commercial, industrial and consumer items cheaply and efficiently and in a semi-automated way.

The problems with rotomolding a spiral are substantial and mostly come from the need to de-mold the part after it is made. A 2-piece mold has been made for a 180° segment of a spiral and have (plastic) welded 14 of these segments together to prove that a 7-turn, plastic spiral will work just like a 7-turn, polyurethane/fiberglass spiral will. However, a mold for a full sized, 7-turn spiral would be extremely costly and have significant risk because it would necessarily be at least a 21-piece mold. This would be difficult to use, be prone to damage during handling, and create a criss-cross of witness lines (where the mold parts come together) that would have to be cleaned up by hand.

An existing method for manufacturing a spiral for minerals separation is as follows: A manufacturer creates a spiral shape out of fiberglass for testing by manual and semi-manual means. Once the test spiral is approved, the manufacturer takes an impression of the approved spiral using gel-coated fiberglass. The approved spiral is called the plug in this manufacturing technology and the impression is called the mold. This mold is made from gel-coat with a fiberglass substrate. To make a spiral from this mold, one first treats the gel-coat surface with a mold release agent. Then polyurethane is sprayed onto the gel-coat surface to a thickness of about 3 to 5 mm. When this hardens, layers of resin and fiberglass mat are laid over the polyurethane to a thickness of about 5 to 10 mm. Once these layers harden, the spiral is loosened from the mold surface by prying. Once the entire spiral is loose, then the spiral can be unwound or unscrewed out of the mold. In general these spirals are 5 to 7 turns long and look almost like a coil spring. The spiral is trimmed, fitted with accessories like feed boxes, discharge boxes, splitters and a center column for support. Improvements are needed in molding spiral separators. The insulation layer, heating elements and cooling tubes are housed within the back side of the mold and is protected by a pieced together cover attached to the mold.

### BRIEF SUMMARY OF THE INVENTION

In one aspect of the present invention there is provided a method for making a spiral for use in spiral separators comprising the steps of: forming a mold for molding the interior surfaces of a spiral which is adapted for use as a spiral separator; selecting a plastic powder to be molded into a spiral; heating the mold to a predetermined temperature sufficient to melt the selected powder; depositing the powder onto the heated mold; melting the powder deposited onto the mold; lowering the temperature of the mold below the melting point of the powder through active cooling; and removing the formed spiral from the mold.

In another aspect of this invention, an insulation layer is provided on the back side of the mold and may, by way of example, constitute a layer of high temperature fiberglass insulation. The insulation layer adds efficiency to the heating process by reducing any thermal losses and also physically protects internal wiring. Further, the insulation layer greatly reduces the temperature on the back side of the mold and thus prevents plastic powder from melting and accumulating there, aiding in the automation of the spiral fabrication process.

Additional steps include: forming the mold of aluminum; selecting linear low density polyethylene; heating the mold to a temperature of 325-375° F.; alternately selecting high density polyethylene; sprinkling the plastic powder onto the mold; and rotating the heated mold around the centerline axis of the spiral being molded.

Other steps include: collecting sprinkled powder that does not attach to the mold; resprinkling the powder collected onto the mold; selecting a predetermined amount of the selected plastic powder; repeating the steps until all the plastic powder selected is melted onto the mold; selecting a material that can be plastic welded after the spiral is molded and attaching a plurality of heating elements and cooling tubes to the back side of the mold that is spaced from the mold front side that receives the powder to be melted.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a pictorial block diagram of the apparatus in accord with the present invention;

FIG. 2 is a front elevation view of the control panel in FIG. 1;

FIG. 3 is a rear view of the mold illustrating a portion of the heaters and cooling tubes of FIG. 1 and with the insulating layer partially cut away;

FIG. 4 is a perspective view of a spiral formed on a mold in accord with the present invention;

FIG. 5 is a perspective view of a completed spiral being removed from the mold; and

FIG. 6 is a perspective view of a completed portion of a spiral.

### DETAILED DESCRIPTION OF THE INVENTION

### Introduction

The invention is a new method and apparatus for manufacturing spirals out of polyethylene such as LLPDE, Linear Low Density Polyethylene and HDPE, High Density Polyethylene or any other thermoplastic material. As used herein, the term “spiral” refers to an entire spiral of perhaps 1-7 spiral turns, as well as a partial spiral turn of about 90°-360°. The new method of manufacturing spirals will use an open mold that is similar to a mold used currently to make polyurethane lined fiberglass spirals. The mold will also have similarities to a roto-mold that is currently used to make hollow plastic parts for consumer, commercial and industrial applications in that it is made of aluminum for good heat transfer.

There are several advantages of using this new method and apparatus, not the least of which include low material cost and low raw spiral cost. Additionally, the new method and apparatus offers both the ability to automate the manufacturing process, rapidly make new molds anywhere in the world and in a manner that is also much more environmentally friendly than the current polyurethane-fiberglass method.

The mold apparatus used for the spiral fabrication process in accord with the present invention is an open mold, unlike a closed roto-mold, and more like the conventional mold used for making polyurethane/fiberglass spirals. The biggest differences are (1) the mold is aluminum instead of fiberglass, (2) the mold is heated by electric cartridge or strip heaters that are controlled to create the ideal conditions to melt powdered plastic, (3) the mold is actively cooled with cooling tubes after the heaters are turned off, and (4) the back side of the mold and the heaters and cooling tubes are coated with an insulating layer that significantly reduces the amount of plastic powder that melts on the back side while improving the efficiency of the heaters and the cooling tubes.

The heaters and cooling tubes are mounted on or in the back side of the mold leaving the front side available to accept the melting plastic. The mold is heated to an appropriate temperature (for example, 325° to 375° F. depending on the plastic chosen) to melt the powdered plastic. The plastic powder is then sprinkled onto the heated mold while the mold is rotated around the centerline axis of the spiral. The powder that does not melt falls below and is collected and re-introduced at the top. A system is provided to store a pre-weighed charge of plastic powder, feed it to the sprinkler, collect it after falling and reintroduce it until all of the powder is melted on the front side of the mold. When the powder is completely melted, the heated mold is actively cooled using the cooling tubes. The spiral part is pried off of the mold until it is freed, then the spiral part is unwound or unscrewed from the mold. Except for de-molding, the entire process can be completely automated.

### Apparatus

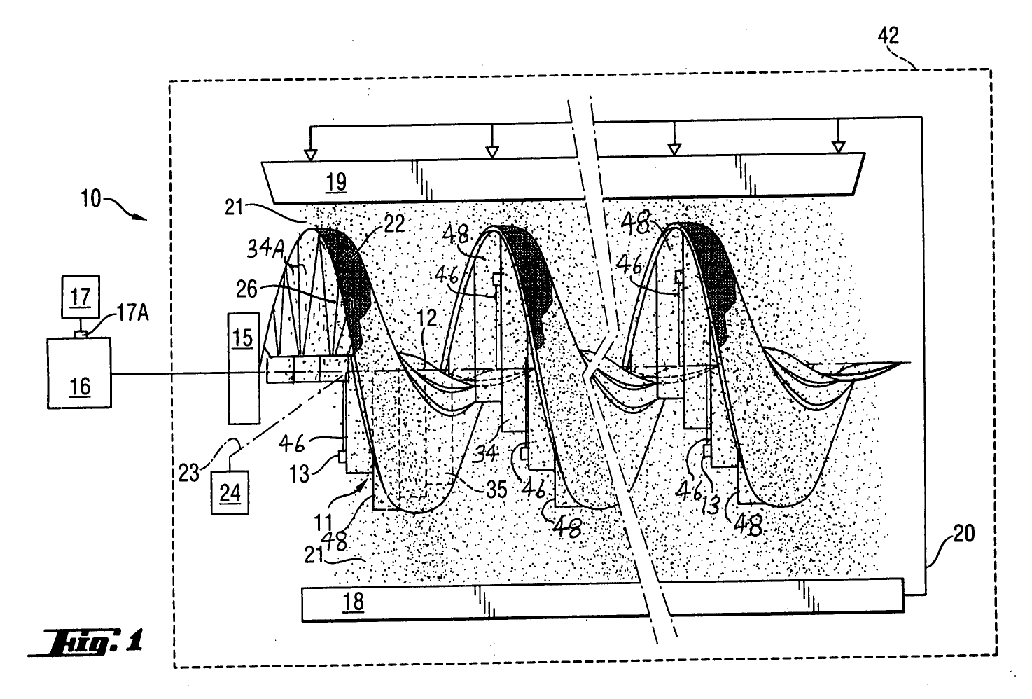

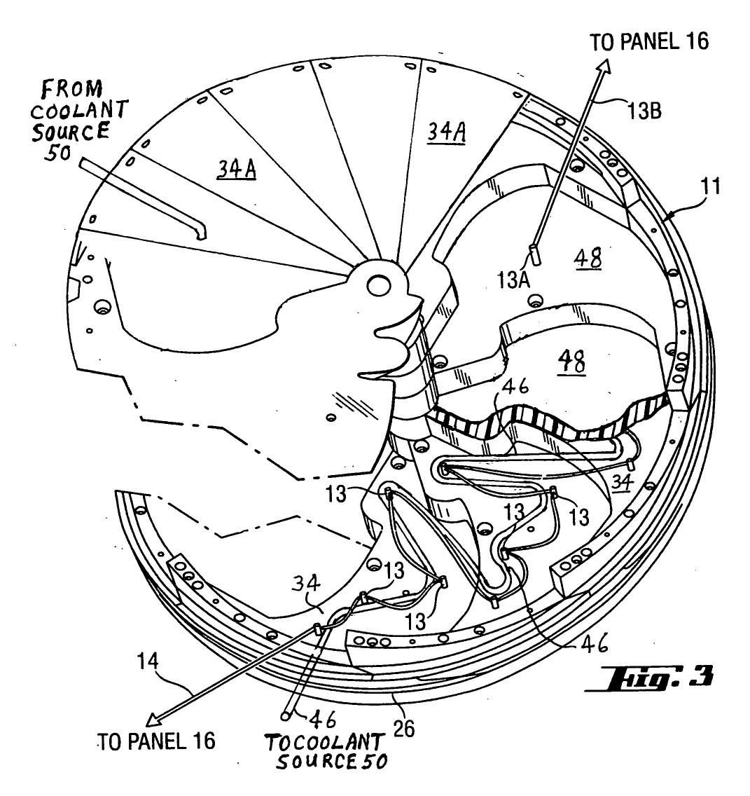

With respect now to the drawings, a block diagram of the molding apparatus in accord with the present invention is shown in FIG. 1 at numeral 10 with features of the mold 11 also shown in FIG. 3. The present description is directed to one or more turns of a spiral separator, preferably 5-7 turns with 3 turns being shown in FIG. 1 and one turn in FIG. 3. Each turn, regardless of size, pitch, etc., is formed in the same manner.

An aluminum mold 11 is made to provide the interior operating surfaces of the desired number of molded spiral turns. Mold 11 is rotatable about the centerline axis 12 by way of drive mechanism 23 driven by motor 24.

Mold 11 is heated via a plurality of spaced heaters 13 (only a few are numbered FIGS. 1 and 3 for ease of illustration) that are embedded in the back side 34 of mold 11 and connected via rotatable wiring harness 15 by power lines 14 shown in FIG. 3. A control panel 16 controls electric power from power supply 17 connected at point 17A. As depicted in FIG. 3, thermocouple 13A provides data via wire 13B for controlling the temperature of the heaters 13.

In accord with a further aspect of this invention and as shown in FIGS. 1 and 3, the apparatus is provided with cooling tubes 46 that are installed across the back side 34 of the mold 11 in a circuitous path in close proximity to the spaced heaters 13. As shown in FIG. 3, the ends of the cooling tubes 46 are coupled to a coolant source 50 to permit a fluid coolant such as air, water or glycol to be circulated across the back side 34 once power to the heaters 13 is interrupted, thereby actively cooling the back side 34 (note FIG. 3). Further, an insulation layer 48 is deposited on the back side 34 of the mold 11 and over the heaters 13 and the cooling tubes 46 in order to provide efficiency to the heating process by greatly reducing thermal losses, and also assisting in the rapid active cooling of the mold 11 once power to the heaters 13 has been discontinued. The high temperature fiberglass insulation layer 48 also serves the purpose of preventing the plastic powder sprinkled from the trough 19 from accumulating on the back side 34 of the mold 11. The back side of the mold 11 is covered by a pieced-together aluminum cover 34A removably affixed thereto, which inhibits accumulation of plastic powder thereon as well as any significant melting thereof on the cover 34A.

The cooling tubes 46 may take various forms such as being attached along the backside 34 of the mold 11 in spaced spiral arrangements as would occur to skilled artisans. Also, the cooling is preferably provided from the coolant source 50 to the tubes 46 while the mold 11 is being rotated (after power to heaters 13 ceases. Several ways to accomplished such cooling are well known in the mechanical and industrial fields.

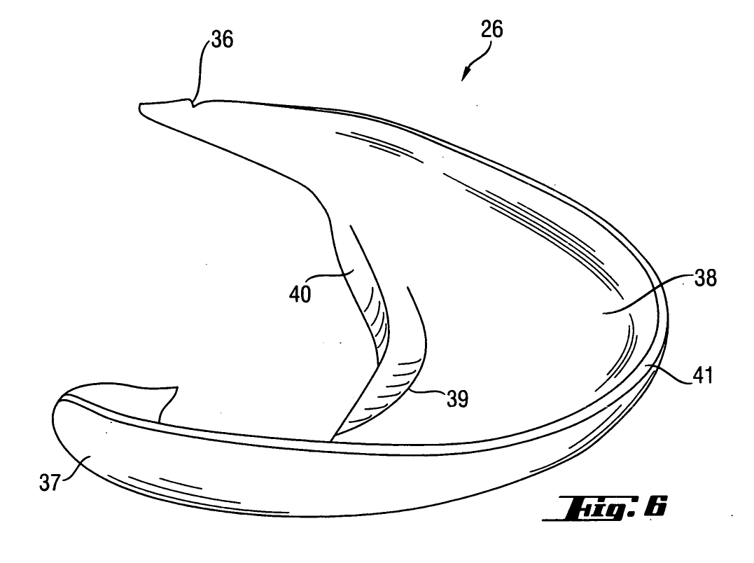

It will thus be appreciated that plastic powder 21 of a selected type and of a predetermined amount is deposited predominantly on the front side 35 of mold 11 via dropping from trough or sprinkler 19, and is recharged with powder 21 that does not stick to the heated mold 11 via powder collector 18 and return-to-top conveyance apparatus 20 which may be pneumatic or mechanical as desired. Molten plastic powder 22 attaches to the front side of mold 11 for the formation of a partially formed spiral 26 (see FIG. 6). Blowers may be used in lieu of sprinkler 19 since the invention includes an enclosure or cabinet 42.

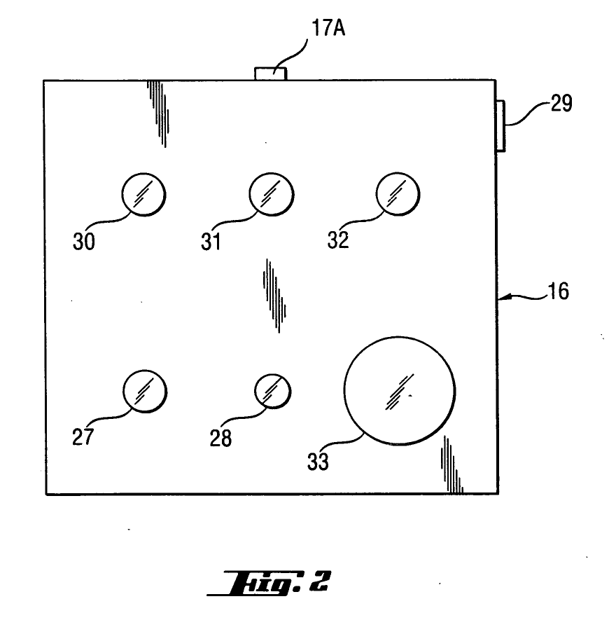

FIG. 2 illustrates the control panel 16 and the emergency stop switch 27, power indication light 28, key lock 29, control knob 33 and other switches 30, 31, 32 as well known in the art, including one switch for controlling operation of the cooling system via cooling source 50.

The specific number and spacing of heaters 13 and cooling tubes 46 (FIG. 3) is determined by the type of plastic powder 21 used as well as by other factors as understood in the art.

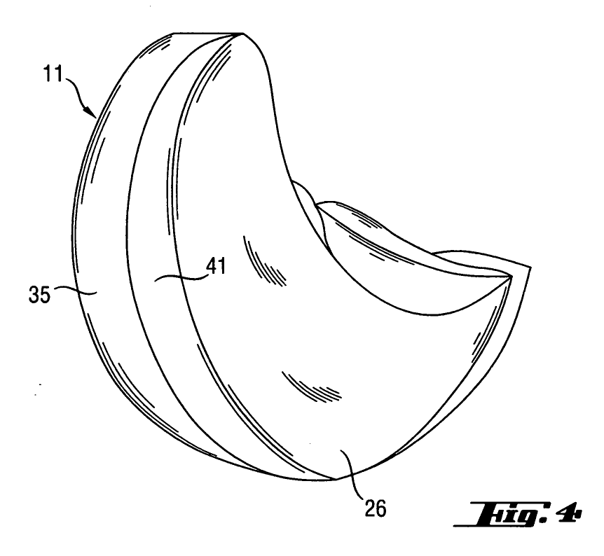

FIG. 4 illustrates the front side 35 of mold 11 with hardened plastic power 22 thereon that is shaped to provide the desired inner surface shape of each completed spiral 26.

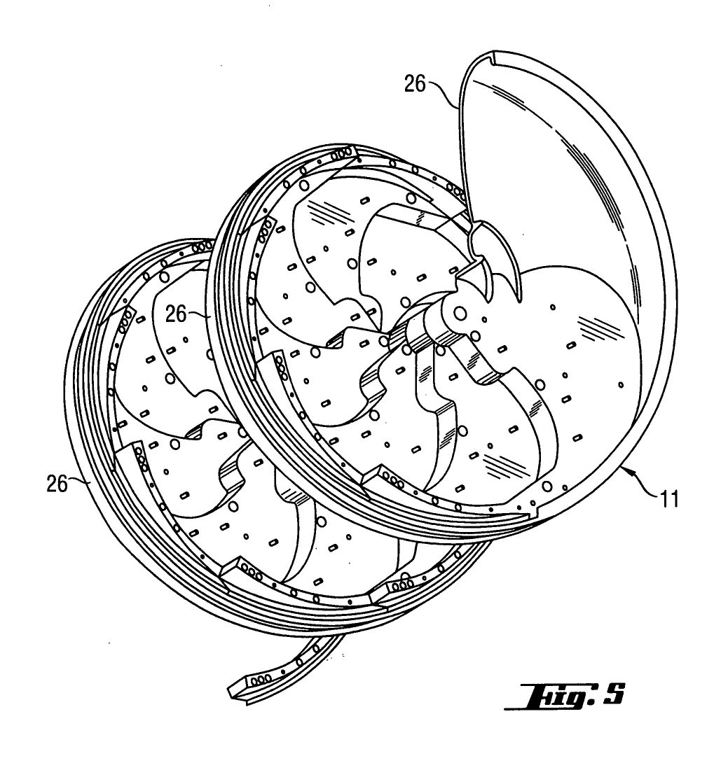

FIG. 5 illustrates a molded spiral 26 being unwound from the mold 11.

FIG. 6 illustrates a completed molded spiral 26. Inlet portion 36 and outlet portion 37 support central tray portion 38, interior channel portion 39, outside flange portion 40, and tray wall 41 are all formed for the use of the spiral separator (not shown) that will include on the order of five to seven completed and trimmed spirals 26 in many applications.

### Methodology

A preferred method of forming one or more spiral turns 26 in accord with this invention is as follows:
A. forming a mold 11 of the appropriate material, preferably aluminum;
B. fitting heaters 13 and cooling tubes 46 to a back side 34 of the mold 11;
C. applying an insulation layer 48 and cover 34A over the heaters 13, cooling tubes 46 and the back side 34;
D. selecting a plastic powder 21 that can be plastic welded, preferably linear low density polyethylene (LLDPE) or high density polyethylene (HDPE) to be molded into each spiral turn;
E. heating the mold 11 to a predetermined temperature appropriate to melt the plastic powder 21 (for example, on the order of 325-375° F.) to render the plastic powder 21 in a molten form 22;
F. selecting a predetermined amount of powder 21;
G. depositing the powder 21 by sprinkling downwardly (or otherwise such as sideways or upwardly) onto the heated mold 11;
H. rotating the heated mold 11 around its centerline axis of the mold for forming each spiral 26;
I. collecting powder 21 that does not attach to the mold 11;
J. again sprinkling the collected powder 21 onto the mold 11;
K. repeating the above steps until substantially all the powder 21 has been deposited as molten plastic 22 onto the front side 35 of the mold 11 thereby forming the spiral 26;
L. discontinuing power to the heaters 13 and actively cooling the mold 11 with the cooling tubes 46; and
M. removing the completed spiral 26 from the mold 11.

Preferably, a plurality of molds 11 are attached together for a total of 5-7 turns to create a spiral to which other structural members such as feed boxes, discharge boxes, splitters and any desired or necessary support elements for the spiral separator to be constructed and used. Such other members may be molded with a spiral in whole or in part in some applications.

There are many advantages to the present approach to spiral manufacture including:

Cost of materials for each spiral is dramatically reduced.

There are significant environmental advantages for thermoplastics over the resins currently used for the polyurethane/fiberglass method.

The thermoplastics are readily available throughout the world.

Spirals could be created using several different plastics layered one upon the other to make the spiral more operator friendly by repeating the above-described steps as appropriate. For Example: The first could be a wear layer like LLDPE, Linear Low Density Polyethylene. The second could be a wear layer of a different color and the third could be a structural layer like HDPE, High Density Polyethylene. The intermediate different colored wear layer would provide an indicator that the spiral is about to wear through and would give the user an opportunity to get ready to change out the spiral before causing an unscheduled shut-down. In addition, logos and markings can be easily applied during or after the molding process.

Importantly, these plastic materials can normally be fabricated and repaired by welding. Accessories that cannot be molded could be attached later by plastic welding. These items may include feed boxes, discharge boxes and splitter handle retainers. The polyurethane of the conventional spiral cannot be repaired or welded.

Preferably, the rotating mold 11 and the associated conveyor/sprinkler apparatus is housed in an enclosure or cabinet 42 to keep the selected powder therein and to keep dirt and moisture away from the molding system. In addition, air can be heated, cooled and dried to control the molding as desired in the circumstances.

While the invention has been described with respect to certain specific embodiments, it will be appreciated that many modifications and changes may be made by those skilled in the art without departing from the spirit of the invention. It is intended therefore, by the appended claims to cover all such modifications and changes as fall within the true spirit and scope of the invention.

What is claimed as new and what it is desired to secure by Letters Patent of the United States is:

1. A method for making a spiral for use in spiral separators comprising the: steps of:
forming a mold for a spiral;
selecting a plastic powder to be molded into a spiral;
heating the mold to a predetermined temperature sufficient to melt the selected powder;
depositing the powder onto the heated mold;
melting at least a portion of the powder onto the heated mold;
lowering the temperature of the mold by discontinuing heating and actively cooling the mold below the melting point of the powder; and then
removing the formed spiral from the mold.

2. The method of claim 1 wherein the heating step comprises the steps of:
fixing plural spaced heaters across a back side of the mold; and
applying power to the heaters during the depositing step.

3. The method of claim 2 wherein the step of discontinuing heating and actively cooling the mold comprises the steps of:
fixing cooling tubes across the back side of the mold;
interrupting power to the heaters; and then
circulating a cooling fluid through the cooling tubes to actively cool the mold.

4. The method of claim 3 further comprising the step of increasing the efficiency of the heaters and cooling tubes by applying an insulation layer over the heaters and cooling tubes.

5. The method of claim 4 further comprising the step of reducing the amount of plastic deposited on the back side of the mold by providing a cover overlying the insulation layer removably affixed to the back side of the mold.

6. The method of claim 5 further comprising the step of selecting a high temperature fiberglass for the insulation layer.

7. A method for making a spiral for use in spiral separators comprising the steps of:
forming a mold for a spiral having opposing first and second sides;
selecting a plastic powder to be molded into a spiral;
applying an insulation layer onto a first side of the mold, the insulation layer of a material to which the selected plastic powder in a molten state does not readily adhere;
heating the mold to a predetermined temperature sufficient to melt the selected powder;
depositing the powder onto the heated mold;
melting at least a portion of the powder onto the second side of the mold;
lowering the temperature of the mold below the melting point of the powder; and then
removing the formed spiral from the mold.

8. The method of claim 7 wherein the temperature lowering step comprises the step of:
discontinuing heating; and then
actively cooling the mold.

9. The method of claim 8 wherein the discontinuous heating and actively cooling steps comprise the steps of:
fixing plural heaters across the first side of the mold;
applying power to the heaters during the depositing step;
fixing cooling tubes across the first side of the mold;
interrupting power to the heater; and then
circulating a cooling fluid through the cooling tubes to actively cool the mold.

10. The method of claim 9 further comprising the step of increasing the efficiency of the heaters and cooling tubes by applying the insulation layer over the heaters and cooling tubes, and covering the back side of the mold.

11. Apparatus for making a spiral for use in spiral separators comprising:
a mold having opposing front and back sides, with said front side shaped as the desired spiral;
at least one heater fitted with said mold and capable of heating said mold to a predetermined temperature sufficient to melt a selected plastic powder;
means for rotating said heated mold; and
means for depositing said selected plastic powder onto said heated mold during rotation to thereby form the desired spiral.

12. The apparatus of claim 11 further comprising:
plural electrical heaters distributed across said back side of said mold; and
means along said back side for distributing electrical power to said plural electrical heaters.

13. The apparatus of claim 12 further comprising:
cooling means along said back side of said mold in proximity to said electrical heaters; and
means for circulating a cooling fluid through said cooling means.

14. The apparatus of claim 13 further comprising:
an insulating layer overlying said back side, said electrical heaters and said cooling means.

15. The apparatus of claim 11 further comprising:
an insulating layer overlying said back side of said mold, and a cover removably attached to the back side of said mold and overlying said insulating layer.

16. The apparatus of claim 11 wherein the means for depositing the selected plastic powder comprises:
a trough containing the selected plastic powder; and
means for releasing the selected plastic powder from said trough and toward said mold.

17. The apparatus of claim 16 further comprising:
a collector for undeposited plastic powder; and
a conveyor for returning the undeposited plastic powder to said trough.

18. The apparatus of claim 11 wherein:
said mold is fabricated of aluminum.

19. The apparatus of claim 11 further comprising:
an enclosure with said mold fitted therein.

20. Apparatus for making a spiral for use in spiral separators comprising:
an enclosure;
an aluminum mold fitted in said enclosure, said mold having opposing front and back sides with said front side shaped as the desired spiral;
plural electrical heaters distributed across said back side of said mold;
means along said back side for distributing electrical power to said plural electric heaters;
cooling means along said back side of said mold in proximity to said electrical heaters;
means for circulating a cooling fluid through said cooling means;
an insulating layer overlying said back side, said electrical heaters and said cooling means;
a trough fitted within said enclosure above the mold for containing the selected plastic powder;
means for releasing the selected plastic powder from said trough and toward said mold;
a collector fitted within the enclosure underneath the mold for collecting undeposited plastic powder; and
a conveyor within the enclosure for returning the undeposited plastic powder to said trough.
